(19) United States
(12) Patent Application Publication
(10) Pub. No.: US 2013/0074953 A1
(43) Pub. Date: Mar. 28, 2013

(54) Water inlet device for a water tank

(71) Applicant: So-Mei Huang, Taiping City (TW)

(72) Inventor: So-Mei Huang, Taiping City (TW)

(21) Appl. No.: 13/200,381

(22) Filed: Sep. 23, 2011

(51) Int. Cl. F16K 31/18

(52) U.S. Cl. 137/409

(57) ABSTRACT

The invention relates to the structure of a water inlet device of a water tank, wherein a float seat is slipped outside an external water-lifting pipe, an internal water-lifting pipe is installed inside the external water lifting pipe, a control valve is fixedly connected on the upper end of the external water-lifting pipe, a valve set is set inside the control valve, the valve set includes a membrane, a positioning plate, a silencing washer, a water feeding plate and a water supply pipe. The shock and vibration caused by inflowing water current may be buffered by using the construction of the valve set, to thereby enhance the silence effect and achieve the purpose of reducing noise.

### BACKGROUND OF THE INVENTION

1. Field of the Invention

The invention relates to the structure of a water inlet device and, more particularly, to the structure of the water inlet device capable to enhance the silence effect, to thereby reduce the produced noise and ensure silence in life.

2. Brief Description of the Related Art

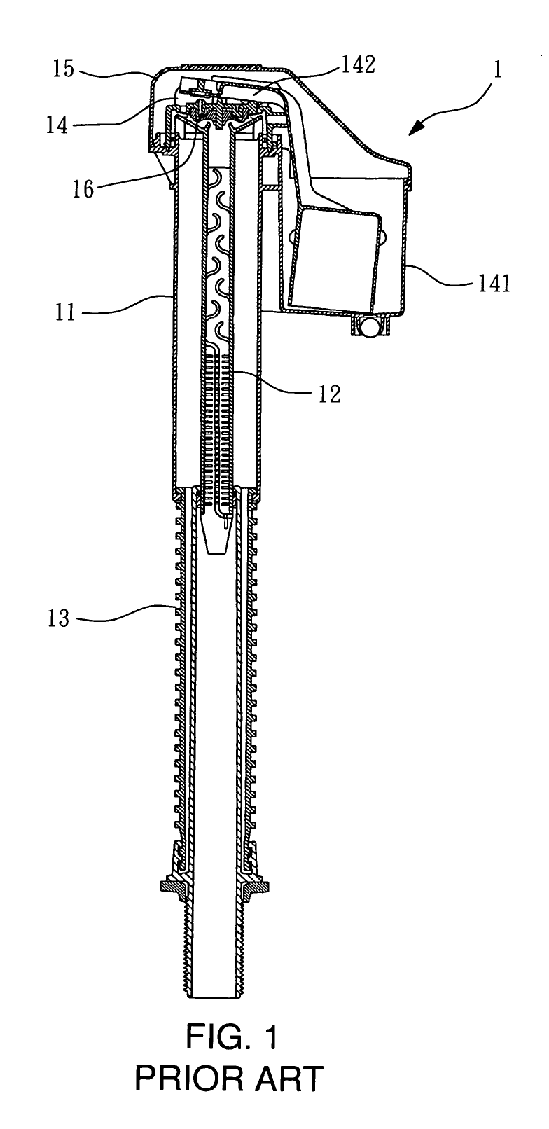

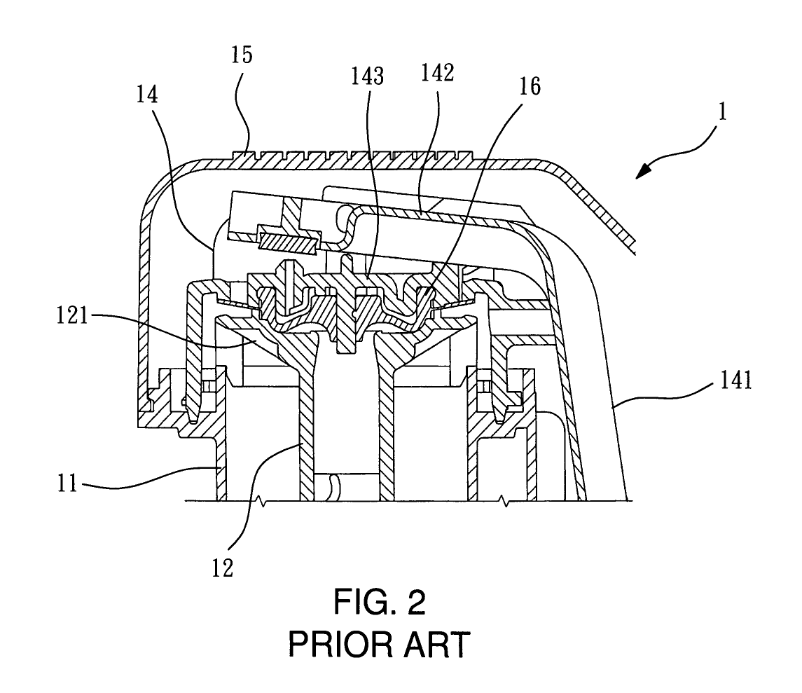

As shown in FIG. 1 and FIG. 2, it is the structure of a conventional water inlet device 1 for a water tank (the structure in U.S. Pat. No. 5,836,346), where an internal water-lifting pipe 13 installed inside an external water-lifting pipe 11, and a water supply pipe 12 is slipped inside the internal water-lifting pipe 13. A valve seat 14 is combined on the upper end of the external water-lifting pipe 11 and the water supply pipe 12, a cap 15 is covered outside the valve seat 14. An infundibuliform plate 121 is set on the upper end of the water supply pipe 12, and a membrane 16 and a controlling seat 143 are installed on it. By changing the position of a float seat 141 due to the floating power to link up with an arm 142 to suppress the air getting in and out the controlling seat 143, to thereby control the membrane 16 for opening or closing water, to thereby achieve the action of flushing and supplying water for the water tank. Although the conventional structure may achieve the purpose of inflowing and supplying water, there are some defects in use as follows:

1. Since the conventional structure lacks current buffer design, the momentum is very strong and often produces water rushing noise during inflowing to disturb quiet life.

2. Due to lack of the anti-shake design of the rubber ring pad between each component of the conventional structure, for example, since the anti-shake rubber ring pads between the water supply pipe 12 and the internal water-lifting pipe 13 are not enough, shaking often occur during current flows in and out, the condition may strengthen the formation of the noise and be criticized by users.

### SUMMARY OF THE INVENTION

In view of this, the inventor finally completed the water inlet device of the water tank according to the present invention after numerous improvements. Namely, the object of the invention is to provide a water inlet device of the water tank capable to enhance the silence effect for effectively buffer the shock and vibration of inflowing current, to thereby enhance the silence effect and decrease produced noise to ensure quiet life.

To achieve the object, according to the invention, a float seat is slipped outside an external water-lifting pipe and an internal water-lifting pipe is set inside the external water-lifting pipe, an external threaded section set on the lower section of the internal water-lifting pipe is used to fasten a fixed set to fix on a water inlet of the water tank, a control valve is fixedly connected on the upper end of the external water-lifting pipe, and a valve set is installed inside the control valve, wherein:

the external water-lifting pipe, the upper end of which is extended outward and formed an outer cylinder, and there is a hollow chamber inside the external water-lifting pipe for setting the internal water-lifting pipe and forming a water passage;

the float seat, which is a seat that may move up and down by the floating power, an aperture is set on one side inside the seat for the external water-lifting pipe slipping inside, and an adjusting arm is connected on another side of the seat;

the internal water-lifting pipe, which is a hollow tube body, an inner tube is set in its center;

the valve set includes:

a water supply pipe, which is inserted inside the inner tube of the internal water-lifting pipe, the water supply pipe has a water inlet passage;

a water feeding plate, a barrel part is set on its upper side, the barrel part has an inner room, an upper column is extended upward from the center of the inner room and a lower column is extended downward, multiple L-shaped slanting ribs are distributed on the peripheral edge of the upper column, at least a water outlet is set on the bottom of the inner room, and the lower column is used for inserting the upper end of the water supply pipe;

a silencing washer, which is a soft pad body, is pasted on the top edge of the barrel part of the water feeding plate, a middle hole is set in the center of the silencing washer;

a positioning plate, which is pasted above the silencing washer, a middle hole and multiple through holes are set in its center;

a membrane, which is a soft pad body, is pasted above the positioning plate, there is a column hole in its central part;

a valve block, which has a valve inner seat with its opening downward inside, an air hole is set on the top of the valve block, a supply tube hole and an air pipe outlet are set on the peripheral edge of the valve block, a supply water tube is connected outside the supply tube hole, an air pipe is connected outside the air pipe outlet, a positioning column is convexly set in the center of the inner side of the valve inner seat;

an arm, which is linked up the adjusting arm of the float seat, one end of the arm is a acting portion, an air-blocking pad is set on the bottom side of the acting portion, the air-blocking pad is used to block the air hole for controlling air passing in and out the air hole;

a cap, which is a cover covered outside the valve block.

The abovementioned water inlet device of the water tank of the present invention, wherein a ring gap and an inner convex edge are set on the inner edge of the outer cylinder of the external water-lifting pipe, the ring gap is used for a first water stop ring embedded in.

The abovementioned water inlet device of the water tank of the present invention, wherein a lateral ring gap is set on outside edge of the barrel part of the water feeding plate for a second water stop ring embedded in.

The abovementioned water inlet device of the water tank of the present invention, wherein at least a convex edge is set on the peripheral edge of the silencing washer.

The abovementioned water inlet device of the water tank of the present invention, wherein the membrane has a lengthwise convex edge on the outside of the central part, a thinner side membrane is extended from the peripheral edge of the lengthwise convex edge.

The abovementioned water inlet device of the water tank of the present invention, wherein a pair of parallel lateral plate is set on the top of the valve block, a shaft hole is set on the lateral plate for a corresponding fulcrum set on two sides of the arm embedding in, and a pivot hole set on another end of the arm is pivot jointed to a shaft hole set on the adjusting arm, and a pivoted bolt is used to set for pivot jointing.

### BRIEF DESCRIPTION OF THE INVENTION

The detail structure, the applied principle, the function and the effectiveness of the present invention can be more fully understood with reference to the following description and accompanying drawings, in which:

FIG. 1 is a cross-sectional diagram of a conventional structure;

FIG. 2 is a partial cross-sectional enlarged diagram of a conventional structure;

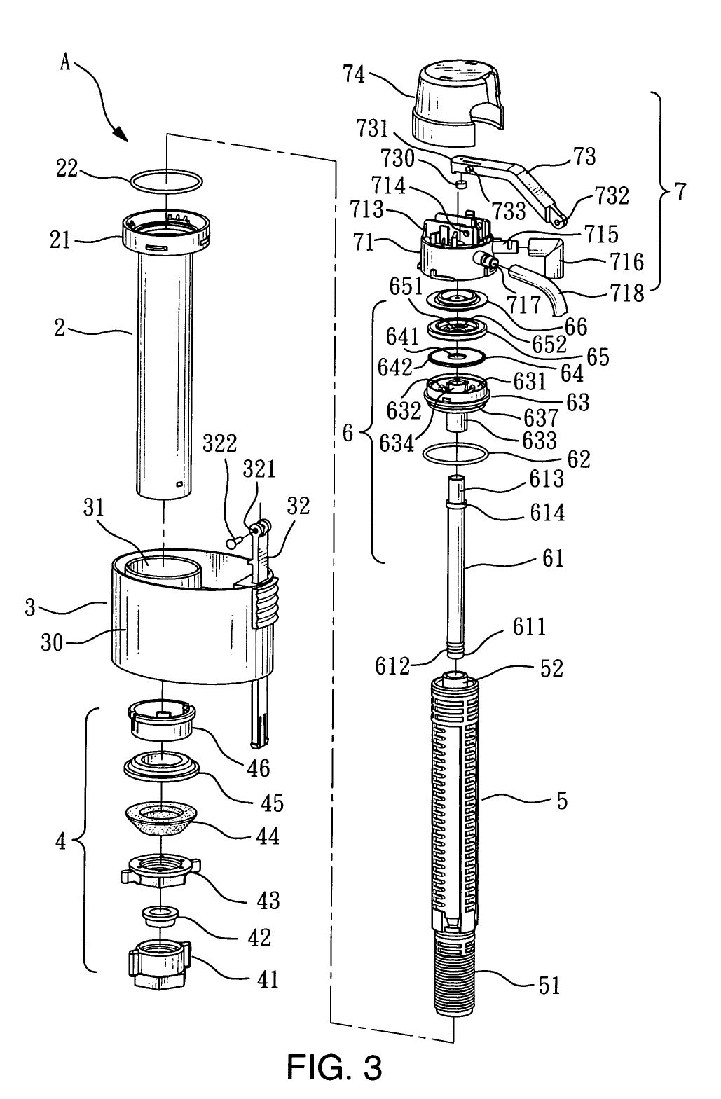

FIG. 3 is a three-dimension exploded diagram of the present invention;

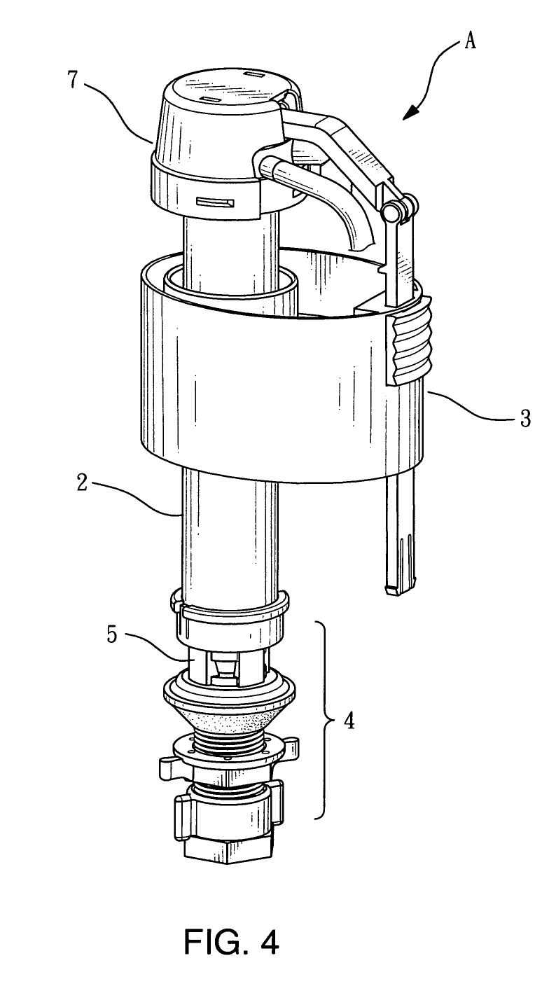

FIG. 4 is a three-dimension diagram of the present invention;

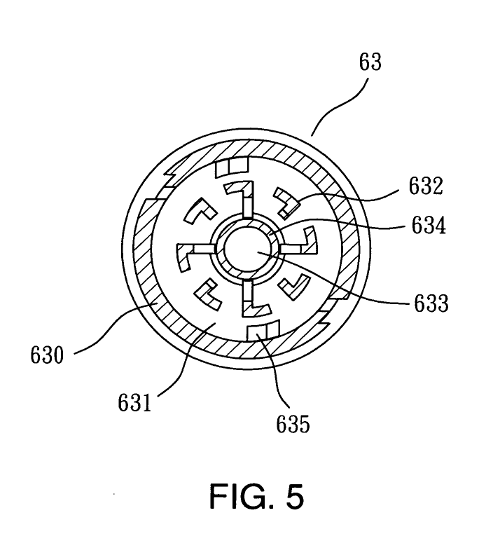

FIG. 5 is a cross-sectional diagram of the water feeding plate of the present invention;

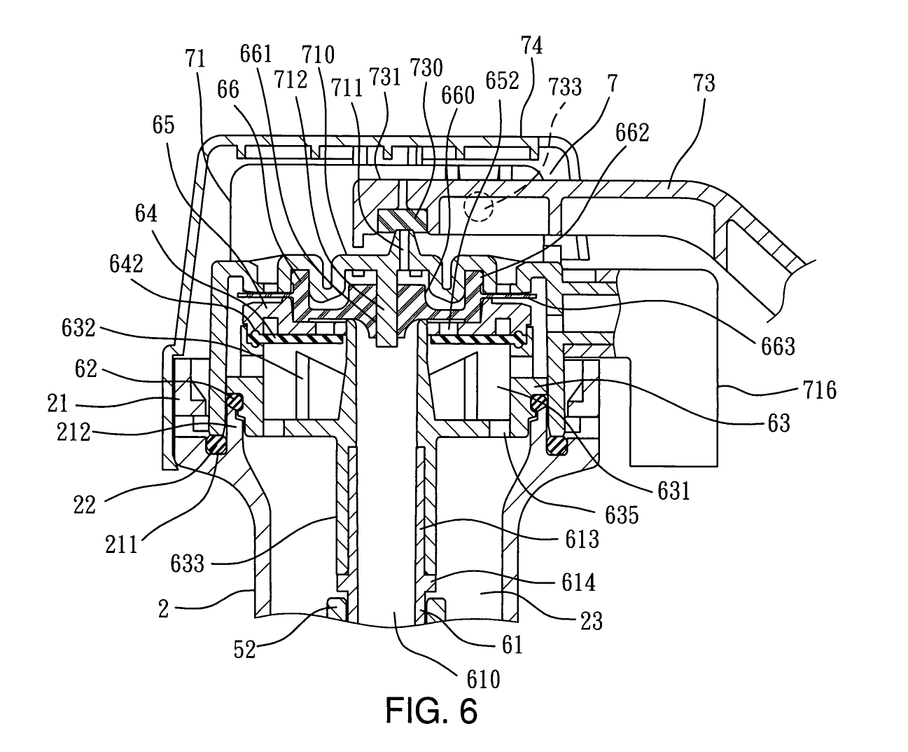

FIG. 6 is a schematic diagram of stopping water inflow of the present invention; and

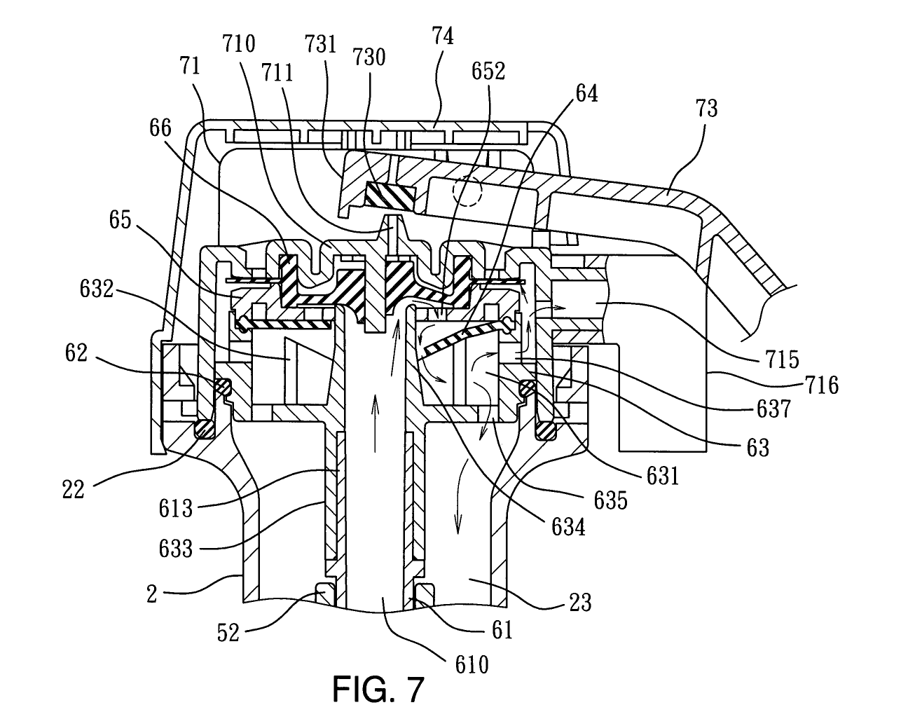

FIG. 7 is a schematic diagram of starting water inflow of the present invention.

### DETAILED DESCRIPTION OF THE PREFERRED EMBODIMENTS

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

Please refer to FIG. 3, FIG. 4 and FIG. 6, according to the water inlet device A of the water tank of the present invention, a float seat 3 is slipped outside an external water-lifting pipe 2, and an internal water-lifting pipe 5 is set inside the external water-lifting pipe 2. An external threaded section 51 set on the lower section of the internal water-lifting pipe 5 is used to fasten a fixed set 4 to fix on a water inlet of the water tank (Since this part is a conventional structure, it is not illustrated in figures). A control valve 7 is fixedly connected on the upper end of the external water-lifting pipe 2, and a valve set 6 is installed inside the control valve 7.

The external water-lifting pipe 2, the upper end of which is extended outward and formed an outer cylinder 21, a ring gap 211 and an inner convex edge 212 are set on the inner edge of the outer cylinder 21, the ring gap 211 is used for a first water stop ring 22 embedded in, and there is a hollow chamber inside the external water-lifting pipe 2 for setting the internal water-lifting pipe 5 and forming a water passage 23.

The float seat 3, which is a seat 30 that may move up and down by the floating power, an aperture 31 is set on one side inside the seat 30 for the external water-lifting pipe 2 slipping inside, an adjusting arm 32 is connected on another side of the seat 30, and a shaft hole 321 is set on the upper end of the adjusting arm 32 for setting a pivoted bolt 322.

The internal water-lifting pipe 5, which is a hollow tube body, an inner tube 52 is set in its center.

The valve set 6 includes:

a water supply pipe 61, which is inserted inside the inner tube 52 of the internal water-lifting pipe 5, the water supply pipe 61 has a water inlet passage 610, at least a water stop ring 612 is set on the location near the lower end 611 of the water supply pipe 61, and a spacing convex edge 614 is set on the location near the upper end 613 of the water supply pipe 61;

a water feeding plate 63, a barrel part 630 is set on its upper side, the barrel part 630 has an inner room 631 (please refer to FIG. 5), an upper column 634 is extended upward from the center of the inner room 631 and a lower column 633 is extended downward, multiple L-shaped slanting ribs 632 are distributed on the peripheral edge of the upper column 634, at least a water outlet 635 is set on the bottom of the inner room 631, and the lower column 633 is used for inserting the upper end 613 of the water supply pipe 61 and being spaced by the spacing convex edge 614; a lateral ring gap 637 is set on outside edge of the barrel part 630 for a second water stop ring 62 embedded in;

a silencing washer 64, which is a soft pad body, is pasted on the top edge of the barrel part 630 of the water feeding plate 63, a middle hole 641 is set in the center of the silencing washer 64, and at least a convex edge 642 is set on the outside edge of the silencing washer 64;

a positioning plate 65, which is pasted above the silencing washer 64, a middle hole 651 and multiple through holes 652 are set in its center;

a membrane 66, which is a soft pad body, its central part 660 is convex upward and has a column hole 661, and has a lengthwise convex edge 662 on the outside of the central part 660, a thinner side membrane 663 is extended from the peripheral edge of the lengthwise convex edge 662.

The control valve 7 includes:

a valve block 71, which has a valve inner seat 710 with its opening downward inside, an air hole 711 and a pair of parallel lateral plate 713 are set on the top of the valve block 71, a shaft hole 714 is set on the lateral plate 713, a supply tube hole 715 and an air pipe outlet 717 are set on the peripheral edge of the valve block 71, a supply water tube 716 is connected outside the supply tube hole 715, an air pipe 718 is connected outside the air pipe outlet 717, a positioning column 712 is convexly set in the center of the inner side of the valve inner seat 710 for inserting in the column hole 611 of the membrane 66;

An arm 73, which is linked up the adjusting arm 32 of the float seat 3, one end of the arm 73 is a acting portion 731, an air-blocking pad 730 is set on the bottom side of the acting portion 731, the air-blocking pad 730 is used to block the air hole 711 for controlling air passing in and out the air hole 711. A corresponding fulcrum 733 is set on each side of the two sides of the arm 73 near the position of the air-blocking pad 730, which is embedded in the shaft hole 714 of the valve block 71, and a pivot hole 732 set on another end of the arm 73 is pivot jointed to the shaft hole 321 of the adjusting arm 32, and the pivoted bolt 322 is used to set for pivot jointing.

A cap 74, which is a cover covered outside the valve block 71.

The abovementioned fixed set 4 of the present invention, which is consisted of an lower fixing nut 41, an inner collar 42, an upper fixing nut 43, a cone-shaped pad 44, a fixed tray 45 and a sleeve joint seat 46, is used for fixing the internal water-lifting pipe 5 on the bottom of the water tank. Since this part is a conventional structure, it is not illustrated in figures.

Please refer to FIG. 6, which is a schematic diagram of closing water of the present invention. When the water level inside the water tank achieves the full water level, the float seat 3 pushes upward due to the floating power effect and links up the air-blocking pad 730 of the arm 73 to block the air hole 711, which causes that air cannot pass in and out, the membrane 66, the positioning plate 65, the silencing washer 64 closely paste on the water feeding plate 63 to stop water inflowing, to thereby achieve the action of closing water.

Please refer to FIG. 7, which is a schematic diagram of opening water of the present invention. When the water inside the water tank flashing into the toilet, the float seat descends quickly and links up the arm 73 to let the air-blocking pad 730 not block the air hole 711, and air may pass in and out. Thus, water inflows from the water inlet passage 610 and the upper column 634 of the water supply pipe 61 and flushes upward to push the membrane 66. Water current passes through the appeared gap, flushes from the through hole 652 and passes the silencing washer 64. In the same time, because of winding and buffered flexible blocking by the silencing washer 64, the momentum of the strong inflow may be retarded and the water noise may be reduced to achieve the first sound silencing effect. A small part of water passing through the silencing washer 64 and entering the inner room 631 may flow into the supply tube hole 715 and the supply water tube 716 for supplying, but most water may flow through the slanting ribs 632 of the inner room 631, and the second sound effect may be achieved by the water retarding effect of the slanting ribs 632. Then, water flows from the water outlet 635 to the water passage 23 and enters the water tank until the water level elevates to the full water level. The float seat 3 simultaneously pushes upward and links up the air-blocking pad 730 of the arm 73 to block the air hole 711, to thereby make the membrane 66, the positioning plate 65, the silencing washer 64 closely pasting on the water feeding plate 63 and stopping water flowing out (as shown in FIG. 6).

I claim:

1. A water inlet device of a water tank, in which a float seat is slipped outside an external water-lifting pipe and an internal water-lifting pipe is set inside the external water-lifting pipe, an external threaded section set on the lower section of the internal water-lifting pipe is used to fasten a fixed set to fix on a water inlet of the water tank, a control valve is fixedly connected on the upper end of the external water-lifting pipe, and a valve set is installed inside the control valve, wherein:
the external water-lifting pipe, the upper end of which is extended outward and formed an outer cylinder, and there is a hollow chamber inside the external water-lifting pipe for setting the internal water-lifting pipe and forming a water passage;
the float seat, which is a seat that may move up and down by the floating power, an aperture is set on one side inside the seat for the external water-lifting pipe slipping inside, and an adjusting arm is connected on another side of the seat;
the internal water-lifting pipe, which is a hollow tube body, an inner tube is set in its center;
the valve set includes:
a water supply pipe, which is inserted inside the inner tube of the internal water-lifting pipe, the water supply pipe has a water inlet passage;
a water feeding plate, a barrel part is set on its upper side, the barrel part has an inner room, an upper column is extended upward from the center of the inner room and a lower column is extended downward, multiple L-shaped slanting ribs are distributed on the peripheral edge of the upper column, at least a water outlet is set on the bottom of the inner room, and the lower column is used for inserting the upper end of the water supply pipe;
a silencing washer, which is a soft pad body, is pasted on the top edge of the barrel part of the water feeding plate, a middle hole is set in the center of the silencing washer;
a positioning plate, which is pasted above the silencing washer, a middle hole and multiple through holes are set in its center;
a membrane, which is a soft pad body, is pasted above the positioning plate, there is a column hole in its central part;
the control valve includes:
a valve block, which has a valve inner seat with its opening downward inside, an air hole is set on the top of the valve block, a supply tube hole and an air pipe outlet are set on the peripheral edge of the valve block, a supply water tube is connected outside the supply tube hole, an air pipe is connected outside the air pipe outlet, a positioning column is convexly set in the center of the inner side of the valve inner seat;
an arm, which is linked up the adjusting arm of the float seat, one end of the arm is a acting portion, an air-blocking pad is set on the bottom side of the acting portion, the air-blocking pad is used to block the air hole for controlling air passing in and out the air hole;
a cap, which is a cover covered outside the valve block.

2. The water inlet device of the water tank as claimed in claim 1, wherein a ring gap and an inner convex edge are set on the inner edge of the outer cylinder of the external water-lifting pipe, the ring gap is used for a first water stop ring embedded in.

3. The water inlet device of the water tank as claimed in claim 1, wherein a lateral ring gap is set on peripheral edge of the barrel part of the water feeding plate for a second water stop ring embedded in.

4. The water inlet device of the water tank as claimed in claim 1, wherein at least a convex edge is set on the peripheral edge of the silencing washer.

5. The water inlet device of the water tank as claimed in claim 1, wherein the membrane has a lengthwise convex edge on the outside of the central part, a thinner side membrane is extended from the peripheral edge of the lengthwise convex edge.

6. The water inlet device of the water tank as claimed in claim 1, wherein a pair of parallel lateral plate is set on the top of the valve block, a shaft hole is set on the lateral plate for a corresponding fulcrum set on two sides of the arm embedding in, and a pivot hole set on another end of the arm is pivot jointed to a shaft hole set on the adjusting arm, and a pivoted bolt is used to set for pivot jointing.
